(19) United States
(12) Patent Application Publication
(10) Pub. No.: US 2011/0221699 A1
(43) Pub. Date: Sep. 15, 2011

(54) TOUCH SCREEN APPARATUS

(75) Inventor: Jung-Won KIM, Suwon-si (KR)

(73) Assignee: SAMSUNG ELECTRONICS CO. LTD., Suwon-si (KR)

(21) Appl. No.: 13/039,648

(22) Filed: Mar. 3, 2011

(30) Foreign Application Priority Data
Mar. 11, 2010 (KR) 10-2010-0021661

(51) Int. Cl. G06F 3/045; G09G 3/36

(52) U.S. Cl. 345/174; 345/87

(57) ABSTRACT

A touch screen apparatus is provided. The touch screen apparatus includes a Liquid Crystal Display (LCD) module for outputting data, a touch panel laminated on the top of the LCD module for inputting data by a touch, and a conductive resin coated to have a constant thickness between the LCD module and the touch panel, and improving adhesion and noise shielding.

### PRIORITY

This application claims the benefit under 35 U.S.C. §119(a) of a Korean patent application filed in the Korean Intellectual Property Office on Mar. 11, 2010 and assigned Serial No. 10-2010-0021661, the entire disclosure of which is hereby incorporated by reference.

### BACKGROUND OF THE INVENTION

1. Field of the Invention

The present invention relates to a touch screen apparatus. More particularly, the present invention relates to a touch screen apparatus used as data input/output means for a variety of kinds of electronic devices.

2. Description of the Related Art

Generally, a variety of kinds of electronic equipment have input devices for data input, and output devices for data output. The input device is typically a key button device and the like, and the output device is typically a display device including a Liquid Crystal Display (LCD) module.

Recently, touch screen apparatuses that provide for both data input and data output using the same device, thus greatly reducing the volume of electronic equipment while diversifying its function, are being put in the market. The touch screen apparatuses dispose a transparent touch panel in an upper part of an LCD module, thereby accomplishing simultaneous input/output. This touch panel is classified into touch panels of various schemes such as a resistive touch panel, a capacitive touch panel, an ultrasonic touch panel, a light (infrared rays) sensing touch panel, an electromagnetic induction touch panel, and the like.

Among these touch panels, the capacitive touch panel is described below. The capacitive touch panel includes a window part formed of a dielectric substance, a dielectric layer coupled to a lower part of the window part and formed of, for example, PolyEthylene Terephthalate (PET) or glass, a conductive substance coating layer partially coated with a transparent conductive substance such as Indium Tin Oxide (ITO) and the like in order to detect a touch on an upper part of the dielectric layer, and an Optical Clear Adhesive (OCA) that is an adhesive layer for coupling the window part with the dielectric layer. The conductive substance coating layer includes a silver paste electrode part for electrically connecting to a predetermined Flexible Printed Circuit (FPC). The FPC mounts a touch screen control unit thereon. An end of the FPC mounting the touch screen control unit includes a connector part, and electrically connects to a main board provided elsewhere in the equipment.

An LCD module is mounted at a lower side of the touch panel. During operation, the LCD module generates noise that degrades the performance of the touch panel. Accordingly, the conventional art provides an air gap of a constant size as a shield layer between a touch panel surface and an LCD surface.

However, the air gap deteriorates the visual aspects of the touch screen, such as the brightness or contrast of a corresponding touch screen, because external light introduced on the touch screen is reflected from a layer of different material. This greatly deteriorates the readability and visibility of the touch screen, and causes a failure to effectively shield against the noise generated in the LCD module.

### SUMMARY OF THE INVENTION

An aspect of the present invention is to address at least the above-mentioned problems and/or disadvantages and to provide at least the advantages described below. Accordingly, an aspect of the present invention is to provide a touch screen apparatus that improves visibility.

Another aspect of the present invention is to provide a touch screen apparatus realized to shield against noise generated in a Liquid Crystal Display (LCD) module, making a contribution to performance improvement of a touch panel.

A further aspect of the present invention is to provide a touch screen apparatus realized to interpose a conductive resin between an LCD module and a touch panel, effectively performing a noise shield function.

The above aspects are achieved by providing a touch screen apparatus.

According to an aspect of the present invention, a touch screen apparatus is provided. The touch screen apparatus includes an LCD module for outputting data, a touch panel laminated on the top of the LCD module for inputting data by a touch, and a conductive resin coated to have a constant thickness between the LCD module and the touch panel, and improving adhesion and noise shielding.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings in which:

FIG. 1 is a perspective diagram illustrating a portable terminal applying a touch screen apparatus according to an exemplary embodiment of the present invention;

FIG. 2 is an explosive perspective diagram illustrating a touch screen apparatus according to an exemplary embodiment of the present invention;

FIG. 3 is a key-part sectional diagram illustrating a construction of a touch screen apparatus according to an exemplary embodiment of the present invention; and

FIG. 4 is a key-part sectional diagram illustrating a construction of a touch screen apparatus according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the drawings, a portable terminal is illustrated and a touch screen panel applied to the portable terminal is illustrated and described, but this does not intend to limit the scope of the present invention. For instance, it is applicable to a variety of electronic equipments including a touch screen panel according to the present invention.

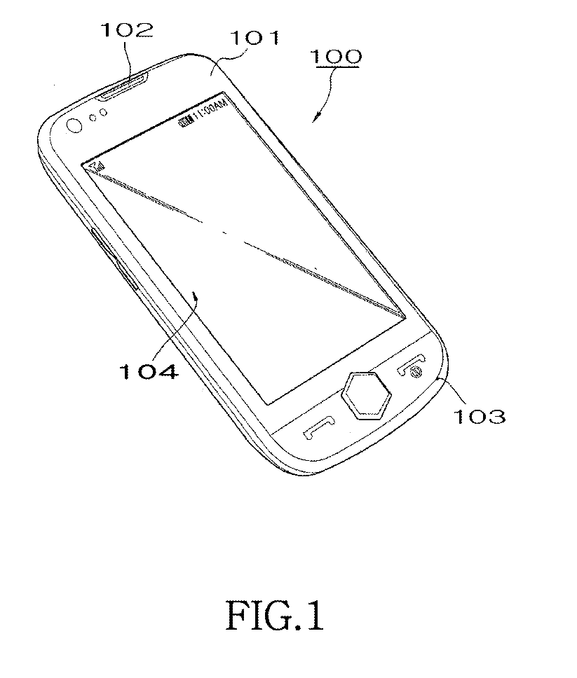

FIG. 1 is a perspective diagram illustrating a portable terminal applying a touch screen apparatus according to an exemplary embodiment of the present invention.

Referring to FIG. 1, the touch screen apparatus 104 is installed in a front surface 101 of the terminal 100. The touch screen apparatus 104 supports a simultaneous data input/output function. A speaker unit 102 for receiving a called party's voice is installed in an upper part of the touch screen apparatus 104, and a microphone unit 103 capable of transmitting a user's voice is installed at a lower side of the touch screen apparatus 104.

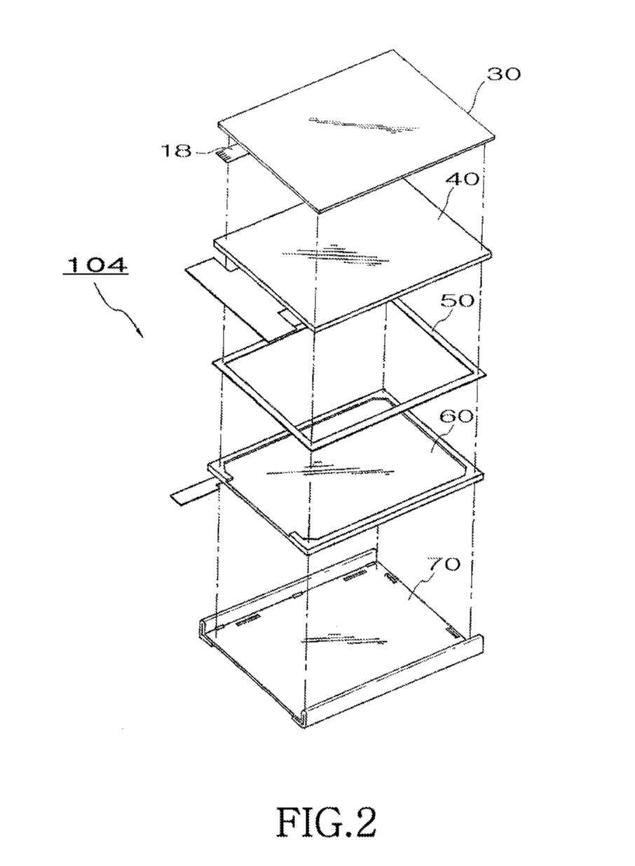

FIG. 2 is an explosive perspective diagram illustrating a touch screen apparatus according to an exemplary embodiment of the present invention.

Referring to FIG. 2, the touch screen apparatus 104 includes a reinforcement plate 70, a backlight unit 60, a double coated tape 50, an LCD module 40, and a touch panel 30 that are laminated successively on the reinforcement plate 70.

The reinforcement plate 70 can be formed of a metal, for example, Steel Use Stainless (SUS) material. The reinforcement plate 70 performs a function of protecting not only the backlight unit 60 but also the LCD module 40 and the touch panel 30 laminated on the backlight unit 60, and permits the touch screen apparatus 104 to be coupled as one assembly. Further, the touch panel 30 is installed to protrude the part of a Flexible Printed Circuit Board (FPCB) 18 externally, and has a connector part for electrically connecting to a substrate of equipment at its end.

According to an exemplary implementation, a predetermined resin is interposed between the LCD module 40 and the touch panel 30. The resin, which may comprise a conductive resin, performs a function of shielding the touch panel 30 from the affection of noise generated in the LCD module 40. Thus, the resin should be coated throughout the front surface of the LCD module 40, and may be a conductive resin of transparent material.

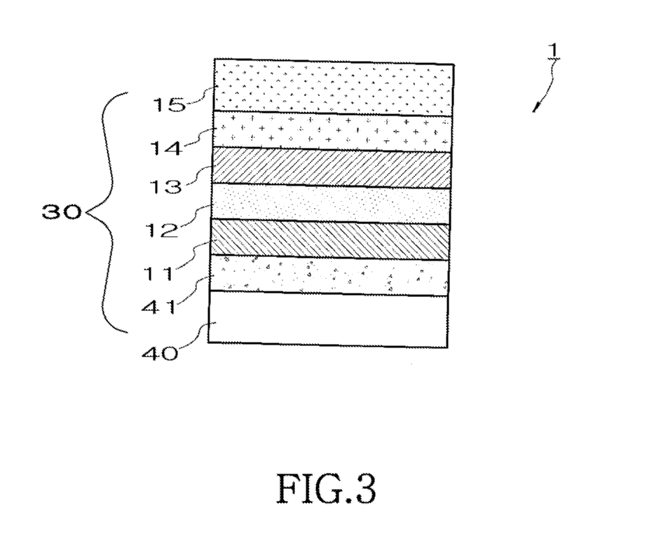

FIG. 3 is a key-part sectional diagram illustrating a construction of a touch screen apparatus according to an exemplary embodiment of the present invention.

Referring to FIG. 3, a touch screen apparatus 1 includes a conductive resin 41 interposed between an LCD module 40 and a touch panel 30. The touch panel 30 includes a dielectric layer 11, a conductive layer 12, an Optical Clear Adhesive (OCA) 13, a window printing layer 14, and a window glass 15. The conductive resin 41 may be formed of a transparent material. The conductive resin 41 may be all coated to have a constant thickness on a surface of the LCD module 40. Also, the conductive resin 40 can be formed to have a thickness at least smaller than that of the existing air gap. For example, the conventional air gap has a thickness of at least 0.3 mm or more, while the conductive resin may have a thickness of 0.1 mm to 0.3 mm.

The dielectric layer (e.g., PolyEthylene Terephthalate (PET) or glass) 11 is formed in the bottom of the touch panel 30. The conductive layer 12 is coated on an upper surface of the dielectric layer 11. The conductive layer 12 may be of a transparent conductive substance including Indium Tin Oxide (ITO) or Indium Zinc Oxide (IZO). The conductive layer 12 has an electrode pattern, and can electrically connect through silver paste electrode parts at either or both ends, which are not illustrated.

Thereafter, the window glass 15 is laminated on an upper part of the conductive layer 12 using the OCA 13 and, as a result, the touch panel 30 is completed. Additionally, the window printing layer 14 can be further interposed at the bottom of the window glass 15 in order to define an active area of the touch panel 30.

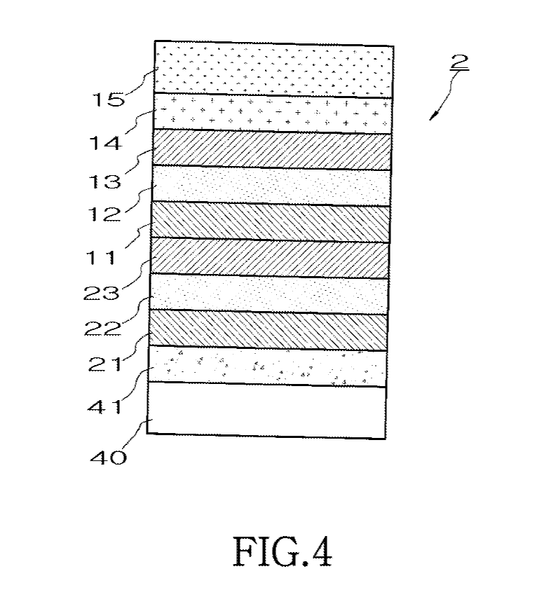

FIG. 4 is a key-part sectional diagram illustrating a construction of a touch screen apparatus according to another exemplary embodiment of the present invention.

Referring to FIG. 4, a touch screen apparatus 2 is illustrated. The touch screen apparatus 2 includes a dual structure touch panel in which a dielectric layer 21, a conductive layer 22, and an OCA 23 other than the construction of FIG. 3 are laminated over again.

Even in this case, a conductive resin 41 can be interposed between an LCD module 40 and the dielectric layer 21 disposed on the LCD module 40.

An exemplary touch screen apparatus according to the present invention shields against noise generated in an LCD module using a conductive resin. Because an air gap is excluded, visibility is improved and resultantly, the reliability of equipment is improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch screen apparatus comprising:
a Liquid Crystal Display (LCD) module for outputting data;
a touch panel formed above the LCD module for inputting data by a touch; and
a conductive resin, between the LCD module and the touch panel, for improving adhesion and noise shielding.

2. The apparatus of claim 1, wherein the conductive resin has a constant thickness.

3. The apparatus of claim 2, wherein the conductive resin comprises a transparent material.

4. The apparatus of claim 3, wherein the conductive resin is on the surface of the LCD module, and has a thickness of 0.1 mm to 0.3 mm.

5. The apparatus of claim 4, wherein the touch panel comprises:
a dielectric layer formed of PolyEthylene Terephthalate (PET) or glass;
a conductive substance coating layer formed of a transparent conductive substance of Indium Tin Oxide (ITO) or Indium Zinc Oxide;
an Optical Clear Adhesive (OCA) on the top of the conductive substance coating layer; and
a window glass laminated on the top of the OCA,
wherein the conductive resin is interposed between the dielectric layer and the LCD module surfaces.

6. The apparatus of claim 5, wherein the touch panel further comprises:
a second dielectric layer on the conductive resin;
a second conductive layer on the second dielectric layer; and
a second OCA layer on the second conductive layer,
wherein the dielectric layer formed of PET or glass is on the second OCA layer.

7. A portable terminal with a touch screen apparatus, the touch screen apparatus comprising:
a Liquid Crystal Display (LCD) module for outputting data;
a touch panel formed above the LCD module for inputting data by a touch; and
a conductive resin between the LCD module and the touch panel, and improving adhesion and noise shielding.

8. The portable terminal of claim 7, wherein the conductive resin has a constant thickness.

9. The portable terminal of claim 8, wherein the conductive resin comprises a transparent material.

10. The portable terminal of claim 9, wherein the conductive resin is on the surface of the LCD module, and has a thickness of 0.1 mm to 0.3 mm.

11. The portable terminal of claim 10, wherein the touch panel comprises:
a dielectric layer formed of PolyEthylene Terephthalate (PET) or glass;
a conductive substance coating layer formed of a transparent conductive substance of Indium Tin Oxide (ITO) or Indium Zinc Oxide;
an Optical Clear Adhesive (OCA) laminated on the top of the conductive substance coating layer; and
a window glass laminated on the top of the OCA,
wherein the conductive resin is interposed between the dielectric layer and the LCD module surfaces.

12. The portable terminal of claim 11, wherein the touch panel further comprises:
a second dielectric layer on the conductive resin;
a second conductive layer on the second dielectric layer; and
a second OCA layer on the second conductive layer,
wherein the dielectric layer formed of PET or glass is on the second OCA layer.
